(19) United States
(12) Patent Application Publication
(10) Pub. No.: US 2007/0133475 A1
(43) Pub. Date: Jun. 14, 2007

(54) Transmission time interval alignment in wcdma systems

(76) Inventors: Janne Peisa, Espoo (FI); Johan Torsner, Masaby (FI)

Correspondence Address: NIXON & VANDERHYE, PC, 901 NORTH GLEBE ROAD, 11TH FLOOR, ARLINGTON, VA, 22203, US

(21) Appl. No.: 10/570,597

(22) PCT Filed: Sep. 11, 2003
(86) PCT No.: PCT/EP03/50618

§ 371 Date: Feb. 5, 2007

(51) Int. Cl. H04B 7/216; H04J 3/06

(52) U.S. Cl. 370/335; 370/350; 370/516

(57) ABSTRACT

A method of aligning Transmission Time Intervals of physical channels in the uplink and downlink directions of a WCDMA communication system. The method comprises measuring or estimating the response processing delay at a user terminal, and delaying the Transmission Time Intervals of an uplink physical channel with respect to a corresponding downlink physical channel or channels by an amount dependent upon the measurement or estimate.

### FIELD OF THE INVENTION

The present invention relates to the alignment of uplink and downlink Transmission Time Intervals in Wideband Code Division Multiple Access (WCDMA) based communication networks.

### BACKGROUND TO THE INVENTION

FIG. 1 illustrates schematically a UMTS network 1 based on the WCDMA standard and which comprises a core network 2 and a UMTS Terrestrial Radio Access Network (UTRAN) 3. The UTRAN 3 comprises a number of Radio Network Controllers (RNCs) 4, each of which is coupled to a set of neighbouring Base Transceiver Stations (BTSs) 5. BTSs are sometimes referred to as Node Bs. Each Node B 5 is responsible for a given geographical cell and the controlling RNC 4 is responsible for routing user and signalling data between that Node B 5 and the core network 2. All of the RNCs are coupled to one another. A general outline of the UTRAN 3 is given in Technical Specification TS 25.401 V3.2.0 of the 3rd Generation Partnership Project. FIG. 1 also illustrates a mobile terminal or User Equipment (UE) 6.

FIG. 1 illustrates a Correspondent Host (CH) 7 which may communicate with the UE 6 via the Internet 8 and the core network 2 (using Serving GPRS Support Node 9 and a Gateway GPRS Support node 10 where the core network is a packet switched GPRS network). User data received at an RNC from the CH 7 via the core network is stored at a Radio Link Control (RLC) layer in one or more RLC buffers prior to sending to the UE 6. User data generated at a UE is stored in RLC buffers of a peer RLC layer at the UE prior to sending to the RNC. Data for transmission is segmented by an RLC layer into RLC Protocol Data Units (PDUs). In a Media Access Control (MAC) Layer, each RLC PDU is placed in a Transport Block (TB) together with an optional MAC header.

Physical channels transport TBs over the air interface between a Node B and a UE. In the uplink direction, two types of physical channel are available to UEs, dedicated and common physical channels. Dedicated physical channels are assigned to and used by only one UE, whilst common physical channels can be shared by several UEs. The two types of dedicated physical channels are the Dedicated Physical Data Channel (DPDCH) and the Dedicated Physical Control Channel (DPCCH). A DPDCH and DPCCH are I/Q multiplexed onto a common carrier (that is to say that one of the DPDCH and DPCCH is modulated using the in-phase carrier reference whilst the other is modulated using the quadrature carrier reference, before being combined together), and will be referred to below as the uplink DPCH. In the downlink direction, the Dedicated Physical Channel (DPCH) is the equivalent of the uplink DPDCH/DPCCH channels. User and control data is multiplexed onto the downlink DPCH. For each DPCH channel carrying data in the uplink direction, there will be a corresponding DPCH channel carrying data in the downlink direction, although in some cases there can be “multicode” transmission in the downlink direction in which case there will be several downlink DPCHs mapped to a single uplink DPCH.

For each physical channel, in the time domain the transmission of data is structured into Transmission Time Intervals (TTI) of fixed but configurable length. A number of TBs can be transmitted in a TTI and the data rate for a given connection is typically varied by transmitting different numbers of transport blocks in different TTIs. The TTI length is configurable to 10, 20, 40 or 80 ms, corresponding to 1, 2, 4 or 8 radio frames of 10 ms each.

A requirement of WCDMA is that the uplink frame structure be synchronised with the downlink frame structure. One reason for this is in order to achieve satisfactory power control over the downlink transmissions. Instructions to increase and decrease the transmission broadcast levels (at the Node B) are included in the uplink frames, and synchronisation is required in order to avoid variations in the resulting power control loop. At the UE, the uplink DPCH frame transmission takes place approximately 1024 chips after the reception of the first detected path (in time) of the corresponding downlink DPCH frame. This means that the offset between the downlink and uplink frames is equal to 0.3 ms. A TTI consisting of F radio frames can only start in frames with a Connection Frame Number (CFN) fulfilling the expression: CFN mod F=0, where the function mod is the modulo function which returns the remainder of CFN/F. Thus the start of the uplink TTI will have a fixed offset relative to the start of the corresponding downlink TTI.

For radio bearers using the so-called Acknowledgement Mode (AM) RLC, the link performance (average Service Data Unit (SDU) delay, throughput) is dependent on the Round Trip Time (RTT) of the link. This problem is described in GB2372172. To achieve a high link performance it is important to achieve a low RTT both on the RLC level and on the TCP level where TCP/IP based applications are used. With reference to FIG. 2, a downlink transmission of data (on the DPCH) takes place in TTI=0. Assume that the transmitted data triggers an acknowledgement in the UE either at the RLC level or at the TCP level. After the received data has been processed at the UE, the UE must wait for the start of a new uplink TTI on the corresponding DPCH in order to send the acknowledgement. In FIG. 1 a TTI of 40 ms (i.e. four loms radio frames) is assumed. In a first example, the UE processing time Tproc is very short (i.e. around 1 frame) and the waiting time will be around one TTI, whilst in the second example Tproc is a little more than one TTI (5 frames) and the waiting time is two TTIs. If the UE processing time for different UEs is random the expected delay due to the TTI alignment is TTI/2, which makes a significant contribution to the RTT of the system.

### STATEMENT OF THE INVENTION

According to a first aspect of the present invention there is provided a method of aligning Transmission Time Intervals of physical channels in the uplink and downlink directions of a bidirectional radio communication system, the method comprising:
measuring or estimating the response processing delay at a user terminal;
delaying the Transmission Time Intervals of an uplink physical channel with respect to a corresponding downlink physical channel or channels by an amount dependent upon the measurement or estimate.

Embodiments of the present invention can reduce the round trip time in the WCDMA system by introducing variable TTI alignment between the downlink and uplink directions. The reduced roundtrip time leads to lower SDU delays and higher throughput particularly in packet data services such as TCP connections.

Preferably, said bidirectional radio communication system is a WCDMA system, although it the present invention may be applied to other systems which are not WCDMA based.

The term “response processing delay” used here refers to the approximate delay, following receipt of data at the user terminal on a downlink physical channel, in having response data ready to send over an uplink physical channel. The amount by which the Transmission Time Intervals (TTIs) of the uplink physical channel are delayed may be the minimum number of radio frame time intervals required to exceed the response processing delay.

Preferably, said data is data which generates an automatic response on the part of the user terminal. That response might be an acknowledgement to the sender of the data, e.g. a Radio Network Controller (RNC) or a correspondent host.

In certain embodiments of the present invention, the user terminal measures its response processing delay and computes the amount of delay to be applied based upon that measurement. The delay amount is signalled to the Radio Access Network (RAN) of the WCDMA system. The user terminal may measure the response processing delay once or only seldom and store that delay in memory for later use. Alternatively, the delay may be measured dynamically.

In an alternative embodiment, the response processing delay is measured by the user terminal and is transmitted to the RAN. The RAN then determines an appropriate delay amount based upon the received measurement, and sends the delay amount to the user terminal.

The response processing delay may be estimated based upon a previous knowledge of the processing properties of the terminal. The terminal is either pre-programmed with this estimate, or the estimate is made known to the RAN. The terminal may alternatively be pre-programmed with a suitable delay amount, or that amount identified to the RAN.

The RAN may use the response processing delay of the user terminal to determine delay amounts for other user terminals communicating with the RAN. The said user terminal may be selected based upon that terminal having the slowest response processing delay. The response processing delay of the said terminal may be combined with the processing delays measured or estimated for other terminal to determine an appropriate delay amount to be applied to the uplink physical channels of all user terminals.

According to a second aspect of the present invention there is provided a user terminal for use with a bidirectional radio communication system, the terminal comprising means for delaying the Transmission Time Intervals of an uplink physical channel with respect to those of a corresponding downlink physical channel or channels by an amount dependent upon a measurement or estimate of the response processing delay of the terminal.

In certain embodiments of the invention, the terminal comprises means for measuring the response processing delay. In other embodiments, the terminal comprises means for storing a predefined response processing delay or delay amount.

The terminal may comprise means for sending the measured or estimated response processing delay or delay amount to a Radio Access Network of the WCDMA system.

According to a third aspect of the present invention there is provided a Radio Network Controller for use in a Radio Access Network of a WCDMA system, the Controller comprising means for processing uplink physical channels taking into account delays, relative to the corresponding downlink physical channels, in the Transmission Time Intervals introduced by the sending user terminals based upon respective measures or estimates of the user terminal processing powers.

According to a fourth aspect of the present invention there is provided a method of controlling the broadcast power levels at a node of a bidirectional communication system, the method comprising sending power control signals to said node from a peer node at regular intervals on an uplink channel, the uplink and downlink channels being synchronised to ensure correct correlation between the power control signals and the respective broadcast power levels, the power control signals being delayed with respect to the downlink signal by an amount dependent upon the response processing delay at said peer node.

### BRIEF DESCRIPTION OF THE DRAWINGS

FIG. 1 illustrates schematically a UMTS network comprising a core network and a UTRAN;

FIG. 2 illustrates schematically UMTS uplink and downlink physical channel configurations where uplink TTIs are significantly delayed relative to the respective downlink TTIs;

FIG. 3 illustrates schematically UMTS uplink and downlink physical channel configurations where the delay applied to uplink TTIs is minimised; and

FIG. 4 is a flow diagram of a method for minimising uplink TTI delay.

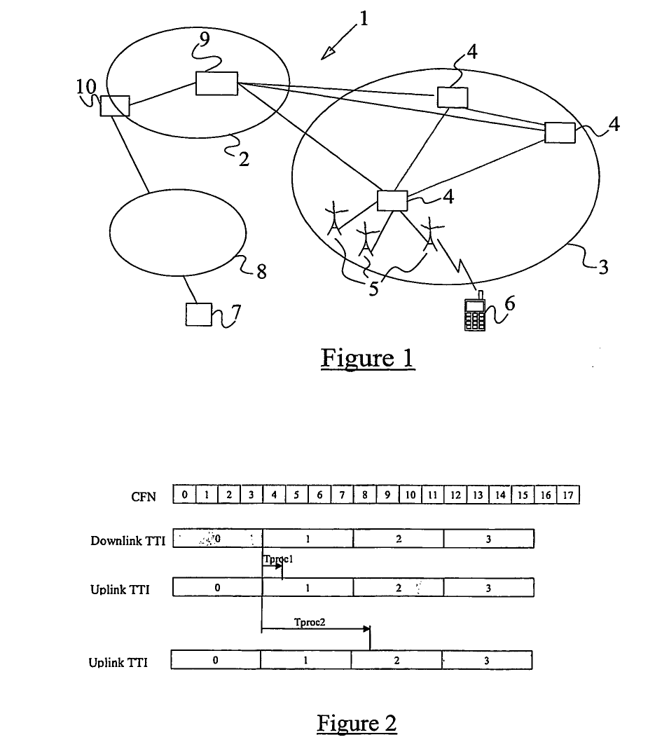

### DETAILED DESCRIPTION OF A PREFERRED EMBODIMENT

As already stated above, according to WCDMA standards it is necessary to align the Transmission Time Intervals (TTIs) of corresponding physical downlink (DPCH) and uplink (DPCH) channels in time to ensure. Traditionally, this has meant synchronising the TTIs. However, this will tend to result in a delay of at least one TTI in sending responses in the uplink direction to data received in the downlink direction.

A simple and elegant solution to this problem is to specify that the uplink TTI starts in frames fulfilling the expression CFN mod F=M, where M is UE dependent (and CFM and F are the Connection Frame Number and number of radio frames in a TTI respectively). M is determined based upon the time Tproc which it takes the user terminal, following receipt of data on a downlink physical channel requiring a response, to generate the required response and have it ready to transmit on the corresponding uplink physical channel. The time Tproc may be measured by the terminal using some suitable self-analysis tool. The time may be measured only once when the terminal is initially configured, or each time the terminal is powered-up.

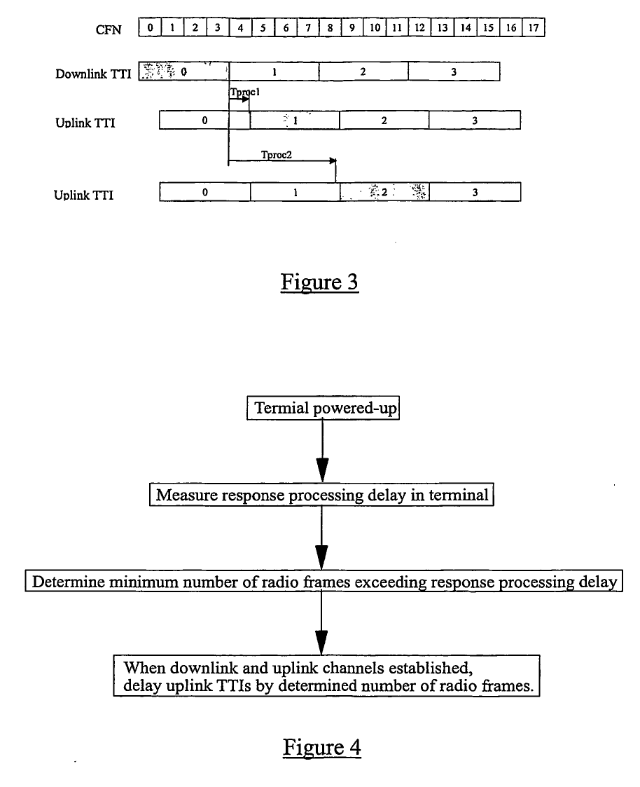

FIG. 3 illustrates two possible scenarios for a given downlink physical channel. In the first scenario, the response processing time is Tproc1. The uplink TTIs are delayed by the minimum number of radio frames required to exceed this time, i.e. 1 radio frame. In the second scenario, the response processing delay is Tproc2 resulting in a delay of 5 radio frames to the uplink TTIs. With the prior art approach, the first scenario would have resulted in a delay of 1 TTI (or 4 radio frames) to the uplink TTIs, whilst the second scenario would have resulted in a delay of 2 TTIs (or 8 radio frames).

As the UE response processing time Tproc is known to the UE, the UE can independently decide the value M based on the processing time and can signal the value M to RAN by layer 3 signalling (e.g. as a UE capability). A method employing this approach is illustrated in the flow diagram of FIG. 4. Alternatively, in order to give the network control over the TTI alignment procedure, the UE can indicate via L3 signalling either the preferred alignment value M or the processing time Tproc. Based on this information the RAN can decide on an appropriate value M and notify the UE of the selected value. This UTRAN may use delay information received from a set of user terminals (or possibly all user terminals in a given cell) to select a single value of M for all of the terminals of that set (or all terminals within the cell).

The alignment procedure described here could potentially be included in later releases of the 3GPP specifications.

It will be appreciated by the person of skill in the art that various modifications may be made to the above described embodiments without departing from the scope of the present invention. For example, a similar result to that achieved by delaying the TTI of the uplink physical channel with respect to the downlink physical channel may be achieved by varying the offset at the physical layer, i.e. delaying the acual frame structure, by an amount dependent upon the response processing delay. However, as this implementation represents a more fundamental change, and may require hardware modifications, it is less likely to be implemented in practice.

1. A method of aligning Transmission Time Intervals of physical channels in the uplink and downlink directions of a bidirectional radio communication system, the method comprising:
measuring or estimating the response processing delay at a user terminal;
delaying the Transmission Time Intervals of an uplink physical channel with respect to a corresponding downlink physical channel or channels by an amount dependent upon the measurement or estimate.

2. A method according to claim 1, wherein said bidirectional radio communication system is a WCDMA system.

3. A method according to claim 1, wherein the amount by which the Transmission Time Intervals (TTIs) of the uplink physical channel are delayed is the minimum number of radio frame time intervals required to exceed the response processing delay.

4. A method according to claim 1, wherein said data is data which generates an automatic response on the part of the user terminal.

5. A method according to claim 4, wherein said response contains an acknowledgement to the sender of the data.

6. A method according to claim 1, wherein the user terminal measures its response processing delay and computes the amount of delay to be applied to uplink Transmission Time Intervals based upon that measurement, and signals that delay amount to the Radio Access Network of the WCDMA system.

7. A method according to claim 1, wherein the response processing delay is measured by the user terminal and is transmitted to the Radio Access Network, and the Radio Access Network determines an appropriate delay amount based upon the received measurement, and sends the delay amount to the user terminal.

8. A method according to claim 1, wherein the response processing delay or an uplink Transmission Time Interval delay amount is pre-programmed into a memory of the user terminal.

9. A method according to claim 8, wherein the response processing delay or an uplink Transmission Time Interval delay amount is sent from the user terminal to the Radio Access Network.

10. A method according to claim 7, wherein the Radio Access Network uses the received response processing delay or an uplink Transmission Time Interval delay amount to determine the delay amount for the said user terminal and, optionally, for other user terminals communicating with the Radio Access Network.

11. A user terminal for use with a bidirectional radio communication system, the terminal comprising means for delaying the Transmission Time Intervals of an uplink physical channel with respect to those of a corresponding downlink physical channel or channels by an amount dependent upon a measurement or estimate of the response processing delay of the terminal.

12. A terminal according to claim 11 and comprising means for measuring the response processing delay or a memory for storing a predefined response processing delay or delay amount.

13. A Radio Network Controller for use in a Radio Access Network of a WCDMA system, the Controller comprising means for processing uplink physical channels taking into account delays, relative to the corresponding downlink physical channels, in the Transmission Time Intervals introduced by the sending user terminals based upon respective measures or estimates of the user terminal processing powers.

14. A method of controlling the broadcast power levels at a node of a bidirectional communication system, the method comprising sending power control signals to said node from a peer node at regular intervals on an uplink channel, the uplink and downlink channels being synchronised to ensure correct correlation between the power control signals and the respective broadcast power levels, the power control signals being delayed with respect to the downlink signal by an amount dependent upon the response processing delay at said peer node.
